(19) United States
(12) Patent Application Publication
(10) Pub. No.: US 2021/0016404 A1
(43) Pub. Date: Jan. 21, 2021

(54) GRIPPING AND POSITIONING ASSEMBLY FOR TRANSPORTING A CLAMPING DEVICE BETWEEN DIFFERENT POSITIONS

(71) Applicant: GRESSEL AG, Aadorf (CH)

(72) Inventors: Flavio ULRICH, Thundorf (CH); Marcel SCHLÜSSEL, Bassersdorf (CH); André JAUCH, Silenen (CH); Eduard RELEA, Männedorf (CH)

(73) Assignee: GRESSEL AG, Aadorf (CH)

(21) Appl. No.: 16/980,513

(22) PCT Filed: Mar. 7, 2019
(86) PCT No.: PCT/EP2019/055751

§ 371 Date: Sep. 14, 2020

(30) Foreign Application Priority Data
Mar. 16, 2018 (DE) 10 2018 106 210.9

(51) Int. Cl. B23Q 7/14; B25J 15/04

(52) U.S. Cl. CPC B23Q 7/1431; B25J 15/026; B25J 15/0408

(57) ABSTRACT

A gripping and positioning assembly for transporting a holding device between different positions includes a coupling arrangement for separably coupling the gripping and positioning assembly to the holding device and holding the holding device securely during transport. The gripping and positioning assembly has an integrated drive for moving the holding device between a hold and a release position to allow the operation of the holding device between a holding and a release position as well as a transporting of the holding device. The coupling arrangement has one or more aligning elements to provide an interlocking connection to the holding device.

The present invention relates to a gripping and positioning assembly for transporting a clamping device between different positions according to the preamble of claim 1. The present invention also relates to a clamping and handling assembly, comprising a clamping device and such a gripping and positioning assembly, and a method of handling workpieces.

DE 10 2015 103 653 A1 discloses a clamping system, with which a clamping vise having clamping jaws, together with a workpiece securely clamped therein, can be transported by means of a gripping and positioning assembly in the form of a gripper between a tray and a processing unit inside a machine tool. To be able to feed the clamping vises, singly or in groups, together with the workpieces securely clamped therein, for processing, and to be able to deposit the finished workpieces along with their clamping vises back on a transport carriage, the clamping vises have a gripper-receiving contour. On two gripper fingers which move relative to one another, the associated gripper has a mating contour complementary to the gripper-receiving contour for securely holding the clamping vise during transport. However, due to the design of the gripping and positioning assembly in the form of a gripper, the clamping vise can only be transported between different positions but cannot be actuated to open or close the clamping jaws.

In DD 291 280 A5, a primary gripper with gripper jaws for receiving an auxiliary gripper is disclosed. The primary gripper has a drive for actuating the auxiliary gripper. The base body of the auxiliary gripper conforms to the geometric shape of the workpieces. The gripper jaws of the primary gripper are also designed to conform to the workpieces, thereby making it possible for both the workpieces and the base body of the auxiliary gripper to be picked up by the gripper jaws.

The problem to be solved by the present invention is to make available a gripping and positioning assembly of the type mentioned above, a clamping and handling assembly comprising such a gripping and positioning assembly, and a method of handling a clamping device in a processing machine, which, in addition to securely transporting the clamping device between different positions also allow the clamping device to be moved between a hold and release position.

This problem is solved by a gripping and positioning assembly with the features of claim 1, by a clamping and handling assembly with the features of claim 13, and by a method with the features of claim 18. Useful embodiments and advantageous refinements of the invention follow from the dependent claims.

In addition to serving as a coupling device for detachably coupling to a clamping device and for securely holding the clamping device during transport, the gripping and positioning assembly according to the present invention has an integrated drive for moving the clamping device between a clamping position and a release position. Thus, a gripping and positioning assembly of this type can transport a clamping device not only between different locations, e.g., back and forth between a tray and a processing position within a machine tool, but it can also actuate the clamping device in the different positions for moving it between a clamping position and a release position. Thus, the gripping and positioning assembly makes it possible for a conventional clamping device to be used not only for securely holding a workpiece during processing but also to be used as a gripping assembly for transporting and handling workpieces. This leads to a simplified loading procedure and to shorter setup times and down times. Reclamping and changeover operations can also take place outside of the machining room. In addition, the coupling device of the gripping and positioning assembly also comprises one or a plurality of aligning elements to provide an interlocking connection to the clamping device. Thus, correctly positioning and connecting the assembly to the clamping device and securely holding the clamping device can be simplified and improved, respectively.

In an especially useful modification of the invention, the drive, which is integrated into the gripping and positioning assembly, has a motor-driven coupling element for connection to an adjusting element of the clamping device for moving the clamping device between the clamping position and the release position. Thus, during the coupling of the gripping and positioning assembly to the clamping device, the drive can be connected to the adjusting element of the clamping device for moving the clamping device between the clamping position and the release position.

In a favorable modification of the invention, the coupling element can be driven by a motor via a gear unit, e.g., in the form of a chain gear mechanism. However, the gear unit can also be a belt drive, a gearwheel drive or another suitable transmission system.

To simplify connecting the coupling element to the adjusting element during coupling of the gripping and positioning assembly to the clamping device, the coupling element, which is pivotably mounted in an enclosure, can be axially movable and biased by a spring.

The coupling device disposed on the gripping and positioning assembly to provide for the detachable connection to the clamping device can favorably comprise a locking unit for holding the clamping device in a locked position. For this purpose, a receiving member interacting with the coupling device can be disposed on the clamping device. This receiving member can be disposed on a separate adapter piece, or it can be integrated into the clamping device. This ensures that the clamping device is securely held during transport.

In a constructively favorable modification of the invention, the locking unit can contain a locking element which can be moved by means of a piston between a locked position and an unlocked position. The locking element can be flexible sheet metal or a rigid latch. It can have a plurality of openings for receiving locking lugs on the adapter piece of the clamping device.

In another favorable embodiment of the invention, the aligning elements of the coupling device can be, e.g., wedge bars, cylindrical pins or conical pins for engaging in wedge-shaped notches or in cylindrical or conical openings. Alternatively, the aligning elements can also be recesses for receiving wedge bars or cone-shaped or cylinder-shaped elements, in particular cylindrical pins or conical pins.

The above-described gripping and positioning assembly can be attached to an industrial robot, or it can be part of an industrial robot.

The present invention further relates to a clamping and handling assembly comprising a clamping device and a gripping and positioning assembly, which can be detachably connected to the clamping device, for transporting the clamping device between different positions. The gripping and positioning assembly comprises a coupling device for detachably connecting the gripping and positioning assembly to the clamping device and for securely holding the clamping device during transport and an integrated drive for moving the clamping device between a clamping position and a release position. The clamping device further comprises an interface in the form of at least one adapter piece disposed on the clamping device for connection to the coupling device of the gripping and positioning assembly. The adapter piece can be configured to be a separate structural component, or to be integrated, e.g., into the base body of the clamping device. Favorably, two adapter pieces arranged opposite to one another can be disposed on the clamping device to connect the clamping device to a coupling device of the gripping and positioning assembly.

The gripping and positioning assembly can further be configured as already described above.

The clamping device dedicated to the gripping and positioning assembly is preferably configured to be a vise having a base body and at least two clamping jaws.

The clamping device can have an additional interface for positioning and holding it on a processing table of a processing machine or on a quick-change system. This interface can, e.g., be designed in the form of at least one clamping pin.

A method, as described by the present invention, for handling a clamping device on a processing machine is characterized in that the clamping device provided for securely holding a workpiece during processing is moved to a workpiece by a gripping and positioning assembly which is detachably connected to the clamping device by means of a coupling device and which comprises an integrated drive for moving the clamping device between a clamping position and a release position, in that the workpiece is picked up by the clamping device through actuation of the drive integrated in the gripping and positioning assembly, and in that the clamping device, together with the picked-up workpiece, is transported by means of the gripping and positioning assembly to a processing position in the processing machine or to a reclamping point.

Additional characteristic features and advantages of the invention follow from the description of a preferred embodiment example below with reference to the drawing. The drawings show:

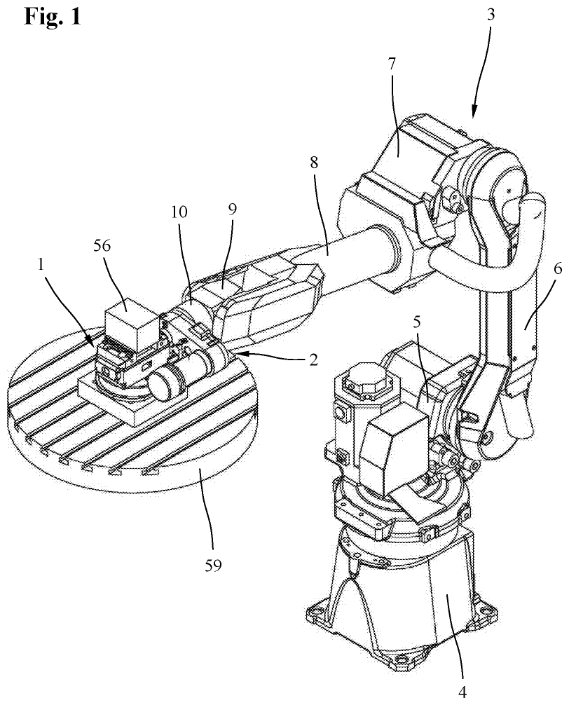

FIG. 1 a perspective view of a clamping and handling assembly comprising a clamping device and a gripping and positioning assembly;

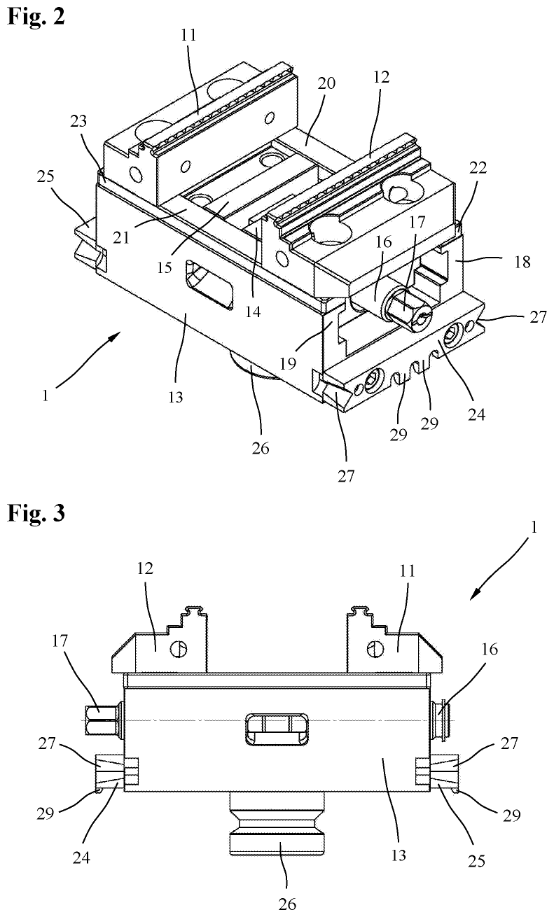

FIG. 2 a perspective view of a clamping device of FIG. 1;

FIG. 3 a lateral view of the clamping device of FIG. 2;

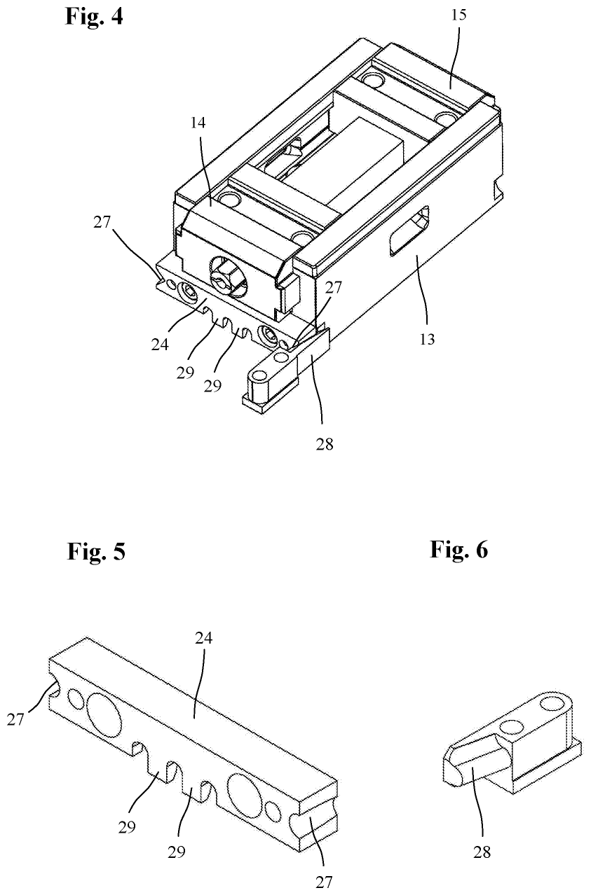

FIG. 4 the clamping device of FIG. 2 with an aligning element without clamping jaws;

FIG. 5 an adapter piece of a clamping device;

FIG. 6 an aligning element dedicated to the adapter piece of FIG. 5;

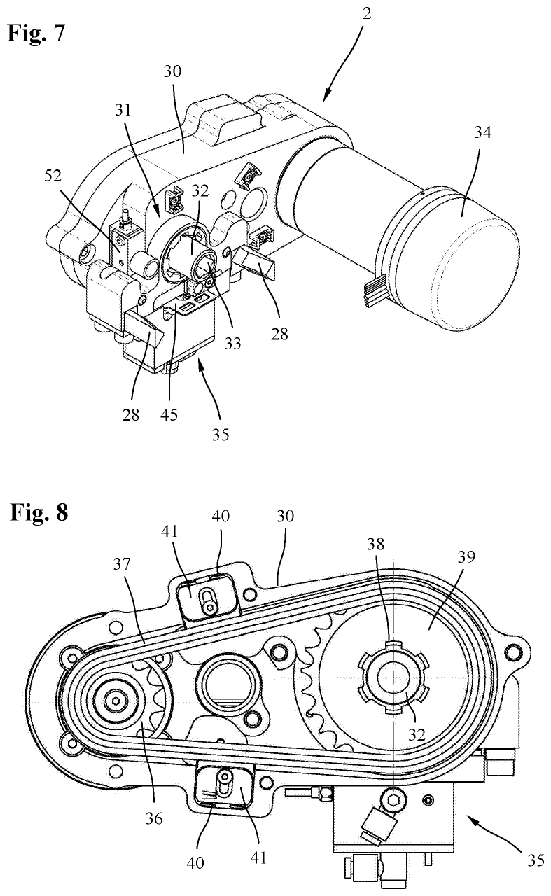

FIG. 7 a perspective view of a gripping and positioning assembly;

FIG. 8 the drive of the gripping and positioning assembly shown in FIG. 5;

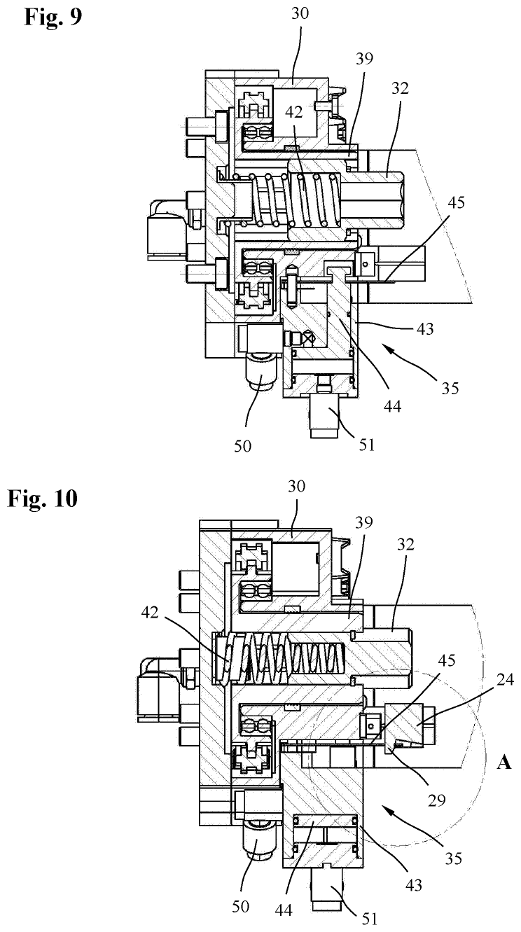

FIG. 9 a cross section through the gripping and positioning assembly of FIG. 7;

FIG. 10 a cross section through the gripping and positioning assembly of FIG. 7 with an adapter piece;

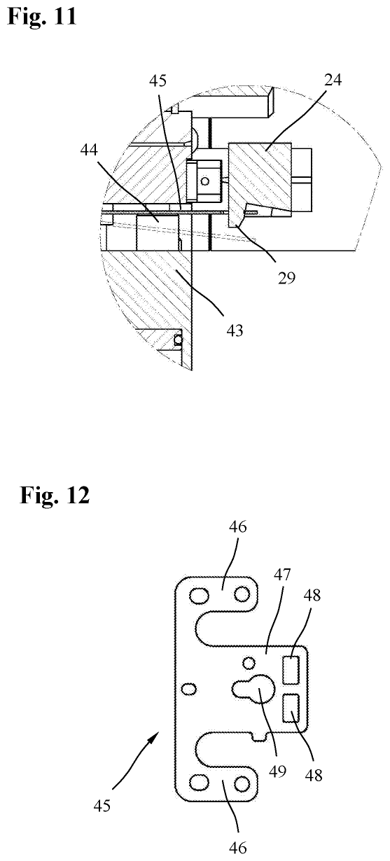

FIG. 11 an enlarged partial view of the area A in FIG. 10;

FIG. 12 a locking element of the gripping and positioning assembly of FIG. 7;

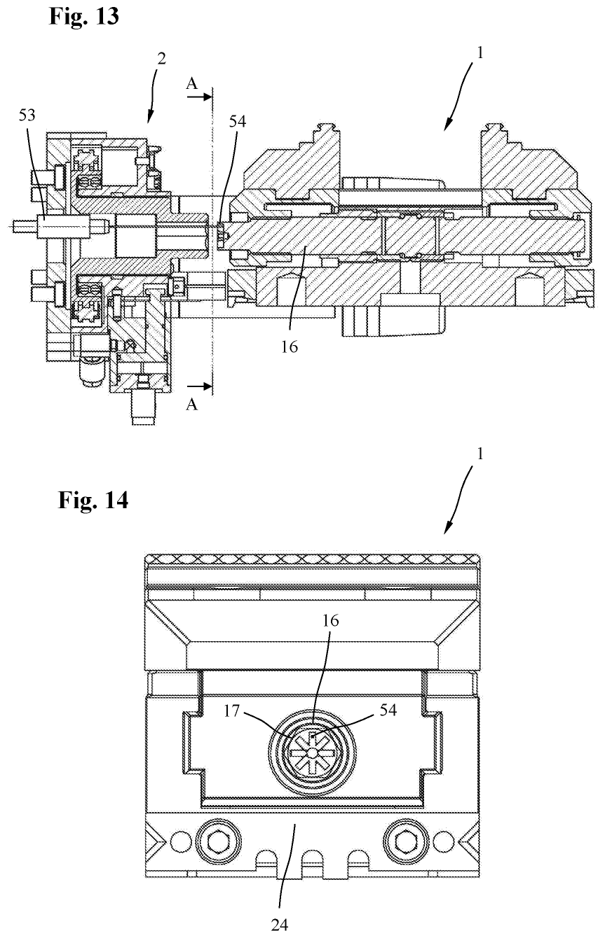

FIG. 13 a sectional view of a further version of a clamping and handling assembly comprising a clamping device and a gripping and positioning assembly;

FIG. 14 a view in the direction of the arrows A-A of FIG. 13;

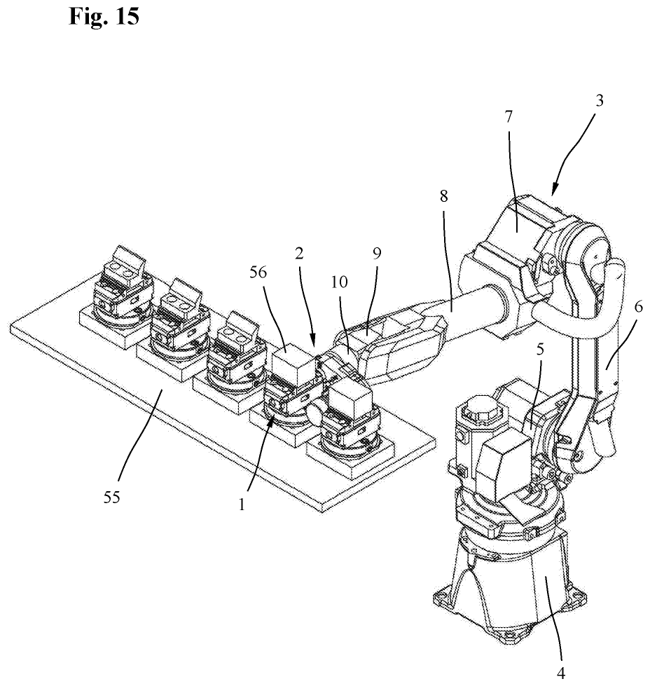

FIG. 15 a clamping and handling assembly during the transport of a clamping device holding a workpiece;

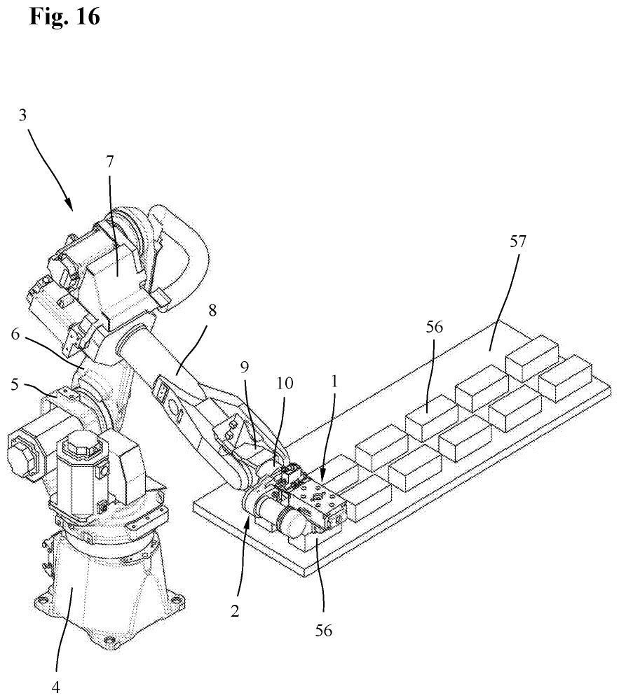

FIG. 16 a clamping and handling assembly during the transport of a workpiece;

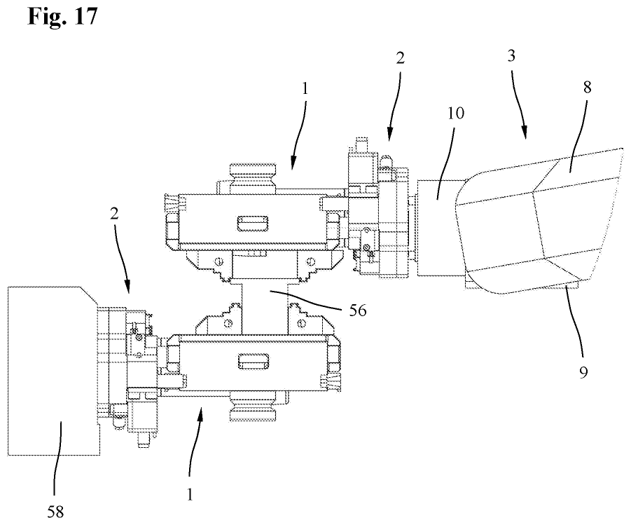

FIG. 17 a clamping and handling assembly during the transfer of a workpiece;

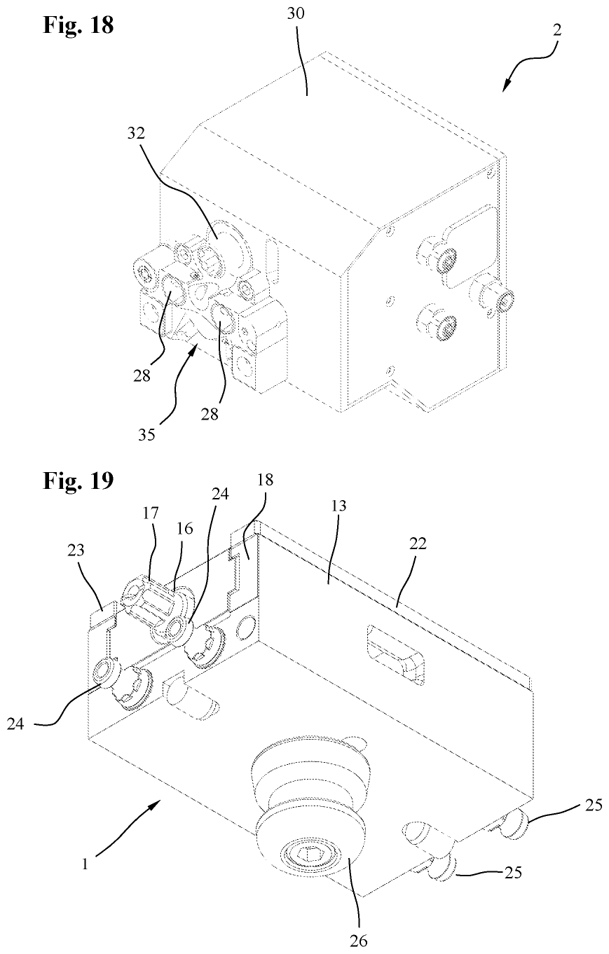

FIG. 18 a perspective view of a second version of a gripping and positioning assembly;

FIG. 19 a perspective view of a second version of a clamping device, and

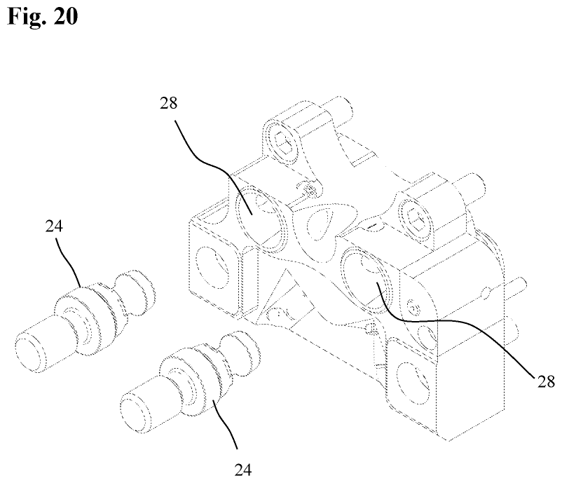

FIG. 20 the aligning element of the gripping and positioning unit, as seen in FIG. 18, and the adapter piece of the clamping device, as seen in FIG. 19.

The clamping and handling assembly shown in FIG. 1 comprises a clamping device 1 for securely holding a workpiece during processing and a gripping and positioning assembly 2 which can be detachably connected to the clamping device and which can be connected to the clamping device 1 for transporting the clamping device between different positions. In the embodiment example shown, the gripping and positioning assembly 2, which can be connected to the clamping device 1, is mounted on a robot 3, here in the form of an articulated arm robot. However, the gripping and positioning assembly 2 can also be mounted on a portal robot or a differently constructed transport and positioning system for moving the clamping device 1 in different directions. The gripping and positioning assembly 2 can also be part of an industrial robot or of a different transport and positioning system.

The robot 3 shown in FIG. 1 comprises a base frame or a stand 4 as is known in the art, on which a carousel 5 is rotatably mounted about a first axis in the form of a vertical axis. On the carousel 5, a swing arm 6 is pivot-mounted about a second axis in the form of a horizontal axis. On the free end of the swing arm 6, an arm 7 is pivotably mounted about a third axis which runs parallel to the second axis and which is also a horizontal axis. The arm 7 carries a hand configuration with a laterally projecting first hand component 8 which is pivotably mounted about a fourth axis on the arm 7. On the fork-shaped free end of the first hand component 8, a second hand component 9 is pivotably mounted about a fifth axis at right angles relative to the fourth axis. An anterior third hand component 10 can be pivotably mounted about a sixth axis of the hand component 9. The gripping and positioning assembly 2 which can be connected to the clamping device 1 is mounted on the anterior third hand component 10.

The clamping device 1 shown from different angles in FIGS. 2 and 3 is configured to be a centric clamping device with two clamping jaws 11 and 12 which can be moved relative to one another. However, the device can also have one stationary clamping jaw and one which can be moved relative thereto, or the device can be a clamping device with multiple clamping elements having more than two clamping jaws. The clamping device 1 which, in the embodiment example shown, has the form of a clamping vis has a base body 13, on which the two clamping jaws 11 and 12 are movably guided by means of slider members 14 and 15 and actuated in opposite directions by an adjustment mechanism with an adjusting element 16, here in the form of an adjusting spindle. The outside profile 17, here in the form of an external hex head, on the free end of the adjusting element 16 allows the adjusting element 16, which is configured to be an adjusting spindle, to be turned so as to adjust the two clamping jaws 11 and 12 relative to one another. Instead of the outside profile 17 in the form of an external hex head, other coupling solutions, e.g., splined shafts, claw attachments, 4-sided connectors or shafts with pin attachments, can be used as well.

As illustrated in FIG. 2, the base body 13 has two separated side walls 18 and 19 with upper guide surfaces 20 and 21. In the embodiment example shown, the two guide surfaces 20 and 21 are located on hardened and polished guide rails 22 and 23. However, the guide surfaces 20 and 21 can also be disposed directly on the side walls 18 and 19. The two slider members 14 and 15 are fitted in and movably guided between the two side walls 18 and 19 of the base body 13. An adapter piece 24 or 25, designed to be connected to the gripping and positioning assembly 2, is attached to the two respective end faces of base body 13. Further, as indicated in FIG. 3, a zero-point clamping element 26 is disposed on the bottom of the base body 13. The zero-point clamping element 26, here configured to be a clamping pin, can also be part of a zero-point clamping system known in the art for accurately positioning and holding the clamping device 1. Using this zero-point clamping element 26, the clamping device 1 can, e.g., be placed accurately positioned on a machining table of a processing machine having an appropriately shaped receiving member and be clamped thereon by a suitable clamping device.

As illustrated in FIG. 4, the adapter pieces 24 and 25, which are attached to the base body 13 of the clamping device 1, have recesses 27 to provide for the interlocking engagement of aligning elements 28 on the gripping and positioning assembly 2. In the embodiment example shown in FIG. 4, the recesses 27 are configured to be wedge-shaped notches on both ends of an adapter piece 24 or 25, and the aligning elements 28 dedicated thereto are configured to be wedge bars. However, the aligning elements 28 can also have a conical shape or be configured to be obliquely arranged cylinders, and the recesses 27 dedicated thereto can be designed to be openings with a conical cross section or oblique cylindrical faces. Other profiles complementary to each other are possible as well. Further, two downwardly projecting locking lugs 29 for holding the clamping device 1 in a locked position on the gripping and positioning assembly 2 are provided on the adapter pieces 24 and 25.

FIG. 5 shows yet another embodiment example of an adapter piece 24, and FIG. 6 shows an aligning element 28 dedicated thereto. In this embodiment example, the aligning elements 28 are configured to be obliquely arranged cylinders, and the recesses 27 dedicated thereto on the adapter piece 24 are configured to be semicircular indentations with oblique cylindrical faces.

The gripping and positioning assembly 2 separately shown in FIG. 7 comprises an enclosure 30, on which the aligning elements 28, here configured to be wedge bars, are disposed. The gripping and positioning assembly 2 further comprises a drive 31, by means of which the clamping device 1 can be moved between a clamping position and a release position. The drive 31 comprises a coupling element 32 which can be connected to the adjusting element 16 of the clamping device 1 and which is rotatably mounted and axially displaceable within the enclosure 30. To detachably connect the coupling element 32, here configured to be a driving bushing, to the adjusting element 16 and to turn the adjusting element, the coupling element has an internal contour 33 complementary to the external contour 17 on the end of the adjusting element 16. By means of a motor 34 which is disposed on the enclosure 30 and which has a first gear stage and a second gear stage, the second gear stage designed as a chain gear mechanism, the coupling element 32 can be turned to actuate the clamping device 1. Further, disposed on the enclosure 30 is a locking unit 35 which interacts with the locking elements 29 on the adapter pieces 24 and 25 of the clamping device 1 and which is provided for holding the clamping device 1 in a locked position on the gripping and positioning assembly 2.

FIG. 8 shows the chain gear mechanism disposed inside the enclosure 30 for turning the coupling element 32 which can be connected to the adjusting element 16. The chain drive mechanism has a drive pinion 36 which is driven by the motor 34 and which is connected via a link chain 37 to an output gearwheel 39 which, by way of a splined shaft connection 38, meshes with the driving bushing 32. Further, two tensioning blocks 41 actuated by compression springs 40 for tensioning the link chain 37 are disposed in the enclosure 30.

The lateral view shown in FIG. 9 indicates that the driving bushing 32 in the output gearwheel 39, which is pivotably mounted in the enclosure 30, is axially movably guided by the splined shaft connection 38 but protected against torsion relative to the output gearwheel 39. The driving bushing 32 is externally biased by a compression spring 42 and can therefore be moved against the force of the compression spring 42 from an extended position, as shown in FIG. 9, into a retracted position. The locking unit 35 comprises a plunger 44 which moves inside an enclosure 43, by means of which plunger a locking element 45 can be moved between a locked position, as shown in FIG. 10, and an unlocked position identified by the broken lines shown in FIG. 11.

In the embodiment example described, the locking element 45, which is separately shown in FIG. 12, is configured to be a leaf spring with two outer attachment parts 46 and a flexible intermediate piece 47. The flexible intermediate piece 47 has two openings 48 provided for receiving the two locking lugs 29 on the adapter piece 24 or 25. Further, the flexible intermediate piece 47 also has an opening 49 provided for the upper end of the plunger 44. However, the locking unit can also be configured to be an articulation component with a hook, a collared plunger or gripper arms.

In the locked position of FIG. 10, the locking element 45, here configured to be a leaf spring, is shown in its upper locked position, not downwardly bent, and the locking lugs 29 on the adapter piece 24 or 25 engage in the respective openings 48. This ensures that the connection between the clamping device 1 and the gripping and positioning assembly 2 is securely locked in position. If the locking element, as a result of the plunger 44 being actuated by compressed air or another compressed medium, is instead downwardly bent, the locking element 45 releases the locking lugs 29 on the respective adapter piece 24 or 25, and the connection between the clamping device 1 and the gripping and positioning assembly 2 can be disconnected. If the plunger 44 is actuated by a compressed medium through the supply connector 50, the locking element 45 is bent downwardly and releases the locking lugs 29 on the respective adapter piece 24 and 25. If the plunger 44 instead is actuated by a compressed medium through the supply connector 51, the locking element 45 is moved into the upper locked position.

As can be seen in FIG. 7, a distance sensor 52 provided to determine the opening width of the clamping device 1 and the position of the slider members 14 and 15 is disposed on the enclosure 30 of the gripping and positioning assembly 2. By means of the distance sensor 52 and a data table in which the width of the jaws is stored, the clearance between the clamping jaws 11 and 12 can be calculated, and the motor 34 can be actuated accordingly. The clamping device 1 can be set to the desired opening width, and a workpiece can be picked up and clamped. After the clamping device 1 is closed, the opening width of the clamping device 1 can be checked by the distance sensor 52. Monitoring the clearance between the clamping jaws 11 and 12 makes it possible to monitor the position in the width direction and the width of the workpiece. To monitor the clearance, preferably an optical, capacitive, ultrasound or laser sensor is used.

FIGS. 13 and 14 show an alternative to the spring-loaded coupling element 32 in the layout shown in FIGS. 9 and 10. In the alternative layout, the coupling element 32, which can be coupled to the adjusting element 16, here configured to be an adjusting spindle, of the clamping device, is not spring-loaded and not axially movably disposed inside the enclosure 30 of the gripping and positioning assembly 2. By means of a sensor 53, the position of the adjusting element 16 can be determined, and the motor can correct the rotary drive for coupling. The sensor 53 can be, e.g., an optical sensor, which is disposed inside the hollow coupling element 32, for detecting a mark or a measuring point 54 on the outside profile 17 of the adjusting element 16.

As shown in FIG. 15, by using the clamping and handling assembly described above, e.g., a clamping device 1, together with a workpiece 56 manually clamped on in a provisioning station 55, can be transported from the provisioning station 55 to a processing table 59 of a processing machine, as shown in FIG. 1.

However, by using the clamping and handling assembly with the gripping and positioning assembly 2 mounted to a robot 3 and with the clamping device 1 coupled to the gripping and positioning assembly, it is also possible, by suitably turning the gripping and positioning assembly 2 as shown in FIG. 16, to pick up a workpiece 56 from a workpiece storage or a tray 57 and to transport it to a processing table of a machine tool. The clamping device 1 can therefore serve as a combination of a clamping and gripping unit.

As shown in FIG. 17, by using an additional gripping and positioning assembly 2, it is possible to clamp a workpiece 56 used in a first processing operation onto the clamp used for a second processing operation. The robot 3 having a first gripping and positioning assembly 2 first transports an empty first clamping device 1 to a stationarily installed second gripping and positioning assembly 2, which can be located, e.g., in a mounting site 58 outside of a machining room. After the empty first clamping device 1 has been transferred to the stationarily installed second positioning device 2, the robot 3 with the first gripping and positioning assembly 2 picks up a second clamping device 1 holding a workpiece 56 machined on one side, moves or pivots over the empty first clamping device 1 to the stationarily installed second gripping and positioning assembly 2 and transfers the workpiece to the first clamping device 1. After setting down the now empty second clamping device 1, the now loaded first clamping device 1 can be detached from the stationarily installed second positioning device 2 and transported to a processing position in a processing machine.

FIG. 18 shows a second design of a gripping and positioning unit 2, and FIG. 19 shows a second design of a clamping device 1 which can be connected thereto. For the sake of clarity, only the important, pertinent reference characters are included in FIGS. 18 and 19. The most important difference from the previously shown design layouts is to been seen in the design of the coupling device and the aligning elements 28 of the gripping and positioning unit 2 and the design layout of the adapter pieces 24, 25 of the clamping device 1, as shown in greater detail as well as separately in FIG. 20. The adapter pieces 24, 25 which are attached to the base body 13 of the clamping device 1 are configured to be two essentially cone-shaped pins provided for the interlocking engagement in the aligning elements 28 of the gripping and positioning unit 2 which are here configured to be recesses. In addition to the designs of the adapter pieces 24, 25 and the aligning elements 28 shown in FIGS. 18 to 20, different profiles that are complementary to each other are possible as well. Further, the gripping and positioning assembly 2 shown in FIG. 18 also has a locking unit 35 (not shown in the drawing) for locking and holding the clamping device 1, wherein the locking unit 35, for example, can have a locking element which can be moved by a plunger relative to the cone-shaped pins.

### LIST OF REFERENCE CHARACTERS

1 Clamping device
2 Gripping and positioning assembly
3 Robot
4 Stand
5 Carousel
6 Swing arm
7 Arm
8 First hand component
9 Second hand component
10 Third hand component
11 Clamping jaw
12 Clamping jaw
13 Base body
14 Slider member
15 Slider member
16 Adjusting element
17 Outside profile
18 Side wall
19 Side wall
20 Guide surface
21 Guide surface
22 Guide rail
23 Guide rail
24 Adapter piece
25 Adapter piece
26 Clamping pin
27 Recess
28 Aligning element
29 Locking lug
30 Enclosure
31 Drive
32 Coupling element
33 Inside contour
34 Motor
35 Locking unit
36 Drive pinion
37 Link chain
38 Splined shaft connection
39 Output gearwheel
40 Compression spring
41 Tensioning block
42 Compression spring
43 Enclosure
44 Plunger
45 Locking element
46 Outer attachment parts
47 Flexible intermediate piece
48 Opening
49 Opening
50 Supply connector
51 Supply connector
52 Distance sensor
53 Sensor
54 Measuring point
55 Provisioning station
56 Workpiece
57 Tray
58 Mounting site
59 Processing table

1-19. (canceled)

20. A clamping and handling assembly comprising a clamping device for securely holding a workpiece during processing and a gripping and positioning assembly detachably connected to the clamping device for transporting the clamping device between different positions,
wherein the gripping and positioning assembly comprises a coupling device for detachably connecting the gripping and positioning assembly to the clamping device and for securely holding the clamping device during transport and an integrated drive for moving the clamping device between a clamped position and a release position,
wherein the clamping device is configured to be a vise with a base body and at least two clamping jaws and has at least one zero-point clamping element for positioning and clamping onto a processing table and at least one adapter piece for connection to the coupling device of the gripping and positioning assembly.

21. The clamping and handling assembly of claim 20, wherein the coupling device of the gripping and positioning assembly comprises one or a plurality of aligning elements to provide for the interlocking connection to the clamping element.

22. The clamping and handling assembly of claim 20, wherein the drive has a coupling element which is rotated by a motor for coupling to an adjusting element of the clamping device.

23. The clamping and handling assembly of claim 22, wherein the coupling element is rotated via a gear mechanism by the motor.

24. The clamping and handling assembly of claim 22, wherein the coupling element is pivotably mounted in an enclosure.

25. The clamping and handling assembly of claim 24, wherein the coupling element is axially movable inside the enclosure and biased by a spring.

26. The clamping and handling assembly of claim 25, wherein a sensor for determining the position of an adjusting element of the clamping device is dedicated to the coupling element.

27. The clamping and handling assembly of claim 24, wherein a distance sensor for determining the opening width of the clamping device is disposed on the enclosure.

28. The clamping and handling assembly of claim 20, wherein the coupling device comprises a locking unit for locking and holding the clamping device.

29. The clamping and handling assembly of claim 28, wherein the locking unit comprises a locking element which is movable between a locked position and an unlocked position by a plunger.

30. The clamping and handling assembly of claim 29, wherein the locking element has a plurality of openings for receiving locking lugs on the clamping device.

31. The clamping and handling assembly of claim 21, wherein the aligning elements are configured to be wedge bars, cones or cylinders for engaging in complementary wedge-shaped, conical or cylindrical recesses on the clamping device and/or wherein the aligning elements are configured to be recesses for receiving wedge bars or cone-shaped or cylinder-shaped elements of the clamping device.

32. The clamping and handling assembly of claim 20, wherein the gripping and positioning assembly is mounted on an industrial robot or is part of an industrial robot.

33. The clamping and handling assembly of claim 20, wherein the clamping device has two adapter pieces arranged opposite to one another for connection to the coupling device of the gripping and positioning assembly.

34. The clamping and handling assembly of claim 33, wherein the adapter pieces are attached to end faces of the base body.

35. The clamping and handling assembly of claim 20, wherein the zero-point clamping element is disposed on the bottom of the base body.

36. A method of handling a clamping device on a processing machine, the method comprising:
moving the clamping device for securely holding a workpiece during processing to the workpiece by a gripping and positioning assembly detachably connected to the clamping device by means of a coupling device, said gripping and positioning assembly having an integrated drive for moving the clamping device between a clamped position and a release position,
picking up the workpiece with the clamping device by actuating the drive integrated in the gripping and positioning assembly, and
transporting the clamping device with the picked-up workpiece by the gripping and positioning assembly to a processing position in the processing machine.

37. The method of claim 36, wherein the clamping device has a zero-point clamping element, by means of which the clamping device can be placed in position on a machining table of the processing machine having an appropriately shaped receiving member for the zero-point clamping element and be clamped thereon by a suitable clamping device.

38. The method of claim 36, further comprising:
transporting an empty first clamping device by means of a first gripping and positioning assembly to a stationarily installed second gripping and positioning assembly,
picking up the workpiece machined on one side held by a second clamping device by means of the first gripping and positioning assembly,
moving the second clamping device over the empty first clamping device on the stationarily installed second gripping and positioning assembly, and
transferring the workpiece to the first clamping device, and after setting down the now empty second clamping device,
disconnecting the now-loaded first clamping device from the stationarily installed second positioning device and
transporting the first clamping device to a processing position in the processing machine.
